(19) United States
(12) Patent Application Publication
(10) Pub. No.: US 2016/0153813 A1
(43) Pub. Date: Jun. 2, 2016

(54) TANK GAUGING SYSTEM AND METHOD

(71) Applicant: Rosemount Tank Radar AB, Goteborg (SE)

(72) Inventor: Christian Skaug, Ojersjo (SE)

(21) Appl. No.: 14/556,606

(22) Filed: Dec. 1, 2014

(51) Int. Cl. G01D 9/00; G01S 13/08; G01F 23/284

(52) U.S. Cl. CPC G01D 9/005; G01F 23/284; G01S 13/08

(57) ABSTRACT

The present invention relates to a tank gauging system, comprising: a field device adapted to determine a process variable of a tank and to provide a process variable value corresponding to the determined process variable, wherein the field device has a field device identification; a time stamping unit adapted to apply an electronic time stamp to said process variable value; and a field communication hub comprising a data storage, wherein the field communication hub is adapted to receive said process variable value from the field device and to store the received process variable value along with the field device identification and the electronic time stamp in said data storage, wherein the system is configured to receive an external time signal, and wherein the applied electronic time stamp is based on the received external time signal.

The present invention also relates to a tank gauging method.

The present invention relates to a tank gauging system and a tank gauging method.

In an existing tank gauging system, for example the Raptor System provided by Rosemount Tank Gauging, a Field Communication Unit polls data from a plurality of field devices via a Tank Hub and stores the data, including measurement values, in a buffer memory. It would however, at least in some applications for such a system, be advantageous to store for each value an associate time indicating when the value was established.

U.S. Pat. No. 8,665,082 (Glenn et al.) discloses an apparatus for use in a wireless remote site monitoring system, comprising: a sensor configured to obtain data, e.g. tank level or inside temperature of the tank; and a control board configured to receive and process data the sensor for transmission to a remote location or server. The data i.a. include the sensor reading and a unique identifier of the sensor. Additional data may include date and time of the sensor reading. The date and time stamp can be applied at the server or at the control board level.

U.S. 20070118334 (Guenter et al.) discloses a field unit arrangement which contains a control PC, a data logger and a level gauge for measuring the level in a connected tank. The data logger is able to record or log data exchanged between the PC and the level gauge in an internal memory of the data logger. The data logger serves for recording data of a field unit or sensor, for example, measuring values with time stamps or echo envelopes.

It is an object of the present invention to provide an improved tank gauging system and method, which in particular may achieve a very accurate and/or consistent time stamp.

According to a first aspect of the present invention, there is provided a tank gauging system, comprising: a field device adapted to determine a process variable of a tank and to provide a process variable value corresponding to the determined process variable, wherein the field device has a field device identification; a time stamping unit adapted to apply an electronic time stamp to said process variable value; and a field communication hub comprising a data storage, wherein the field communication hub is adapted to receive said process variable value from the field device and to store the received process variable value along with the field device identification and the electronic time stamp in said data storage, wherein the system is configured to receive an external time signal, and wherein the applied electronic time stamp is based on the received external time signal.

The time signal is ‘external’ in that it comes from or at least originates from outside of the system. By applying the electronic time stamp based on a time signal from outside of the system, for example from an external time standard like an atomic clock, a very accurate time stamp may be achieved. Furthermore, in case time stamps are applied in various units in the system, the external time signal ensures that the time/clock of one unit may match the time/clock of another unit so that time stamps are uniformly and consistently applied throughout the system.

The time stamping unit may be included in the field communication hub. Here, the applied electronic time stamp may be the current time and date as indicated by the external time signal when the process variable value is received by the field communication hub. The field communication hub comprises may comprise an internal clock which is synchronized by the external time signal, wherein the applied electronic time stamp is the current time and date of the internal clock when the process variable value is received by the field communication hub.

The time stamping unit may be included in the field device. Here, the applied electronic time stamp may be the current time and date as indicated by the external time signal when the process variable value is sampled by the field device.

The external time signal is provided from an external time standard outside of the tank gauging system. The external time standard may for example be an atomic clock.

The system may further comprise an internal computer adapted to receive the external time signal from outside of the system. Using an internal computer may increase the security of the system.

The process variable may a filling level of a product contained in the tank. The process variable can also be temperature, pressure, etc.

The field device may be a radar level gauge. The field device may for example be a non-contact radar level gauge or a guided wave radar level transmitter.

The system may further comprise a second field device adapted to determine a second process variable of said tank or another tank and to provide a second process variable value corresponding to the second determined process variable, the second field device having a second field device identification, wherein the field communication hub is adapted to receive the second process variable value from the second field device and to store the received second process variable value along with the second field device identification and a second electronic time stamp applied by the time stamping unit to the second process variable value based on the external time signal.

According to a second aspect of the present invention, there is provided a tank gauging method, comprising: in a time stamping unit of a tank gauging system, applying an electronic time stamp to a process variable value, the process variable value corresponding to a process variable of a tank, which process variable is determined by a field device of the tank gauging system, wherein the applied electronic time stamp is based on an external time signal; and in a field communication hub of the tank gauging system, storing the process variable value along with the electronic time stamp and a field device identification of said field device. This aspect may exhibit the same or similar features and technical effects as the first aspect of the invention, and vice versa.

The electronic time stamp may be applied when the process variable value is received by the field communication hub. Alternatively, the electronic time stamp may be applied when the process variable value is sampled by the field device.

The method may further comprise: receiving the external time signal from a time standard outside of the tank gauging system

These and other aspects of the present invention will now be described in more detail, with reference to the appended drawings showing one or more embodiments of the invention.

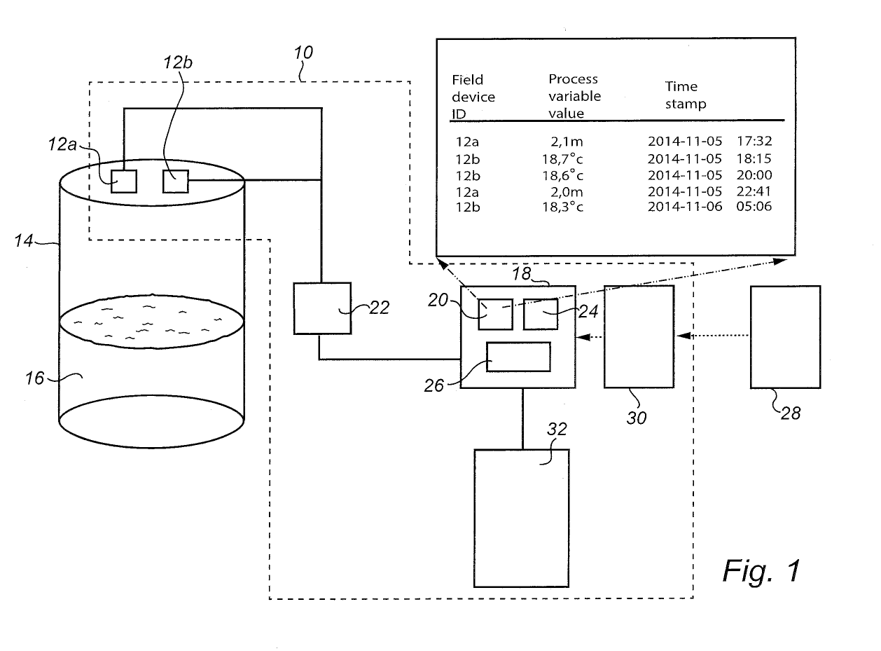

FIG. 1 is a block diagram of a tank gauging system according to an embodiment of the present invention.

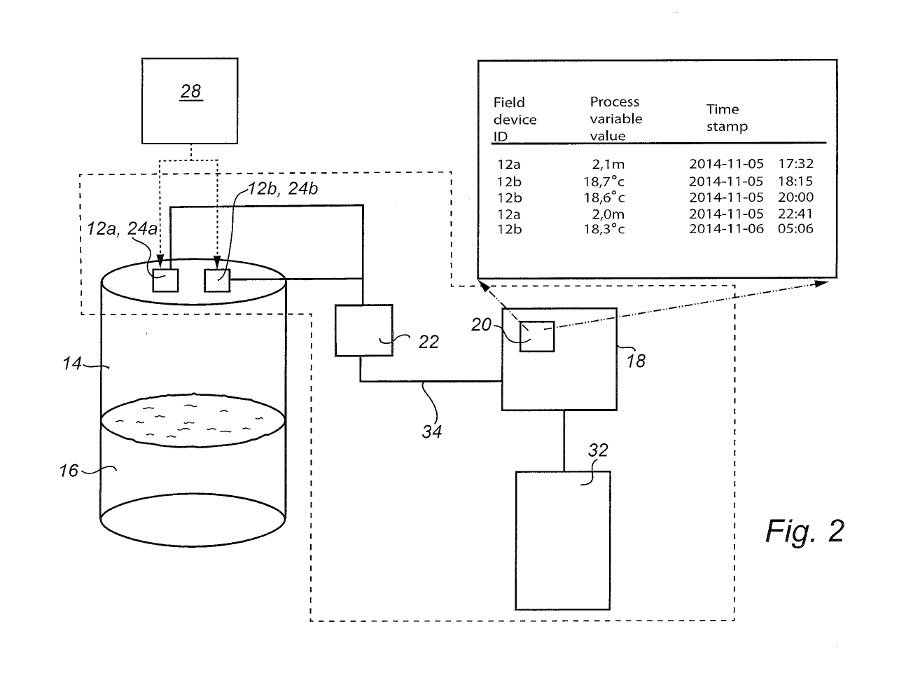

FIG. 2 is a block diagram of a tank gauging system according to another embodiment of the present invention.

FIG. 1 illustrates a tank gauging system 10 according to an embodiment of the present invention. The system 10 comprises two field devices 12a, 12b. Each field device 12a, 12b is adapted to determine a process variable of a tank 14, and to provide a process variable value corresponding to the determined process variable. The first field device 12a may for example be adapted to detect a filling level of a product 16 contained in the tank 14. The first field device 12a may for example be a non-contact radar level gauge or a guided wave radar level transmitter. The second field 12b may for example detect tank temperature, pressure, or the like.

Each field device 12a, 12b also has a unique field device identification (ID). The field device identification may for example be a unique number, name or other digital and/or electronic designation associated with the field device in question.

The system 10 further comprises a field communication hub 18. The field communication hub comprises an electronic data storage (memory) 20. The field communication hub 18 is generally adapted to receive process variable values from the field devices 12a, 12b, and to store each received process variable value in the data storage 20 along with the field device identification associated with the field device that the particular process variable value was received from. The field communication hub 18 may for example poll the field devices 12a, 12b in order to receive the process variable values. Communications between the field devices 12a, 12b and the field communication hub 18 may be wired or wireless. A tank hub 22 may optionally be arranged between the field devices 12a, 12b and the field communication hub 18, as shown in FIG. 1.

The system 10 further comprises a time stamping unit 24. In the embodiment shown in FIG. 1, the time stamping unit 24 is incorporated in the field communication hub 18. The time stamping unit 24 may be realized with suitable software and/or hardware. The time stamping unit 24 is adapted to apply electronic time stamps to the process variable values received by the field communication hub 18. The applied time stamps are based on an external time signal (indicated by dotted arrow in FIG. 1) received from outside of the system 10. The external time signal is typically electronic. Each time stamp is typically digital, and it may comprise time and date. It may also comprise UTC (Coordinated Universal Time), time zone data, daylight saving data, etc. Time zone and daylight saving data ensure that time stamped process variable values can be analyzed locally as well as globally. An applied time stamp may for example be the current time and date as indicated by the external time signal when a process variable value is received by the field communication hub 18. In particular, the field communication hub 18 may comprises an internal clock 26 which is synchronized by the external time signal, wherein the applied time stamp may be the current time and date of the internal clock 26 when the process variable value is received by the field communication hub 18. Each applied time stamp is stored in the data storage 20 of the field communication hub 18 along with the associated process variable value and field device identification, as exemplified in FIG. 1.

The external time signal may for example come from an external time standard 28, such as an atomic clock. The external time signal may generally be received by an input of the system 10, for example via radio or a wired connection. In particular, the field communication hub 18 may be configured to receive the external time signal directly from the external time standard 28, for example via an Internet connection. Alternatively, the system 10 may comprise an internal computer, such as an internal server 30, that first receives the external time signal, and then relays it to the field communication hub 18. Using the internal server 30 may increase the security of the system 10, since the field communication hub 18 does not have to be directly connected to the outside of the system 10.

The system 10 may further comprise a control room 32 connected to field communication hub 18, whereby data stored in the field communication hub 18 promptly can be sent to the control room 32. The control room 32 may calculate a volume of the product 16 based on the detected filling level, which calculated volume may be electronically stored along with the time stamp related to the detected filling level. In case the control room 32 is connected to additional field communication hubs (not shown), such additional field communication hubs may beneficially apply time stamps based on the same external time signal as field communication hub 18. In this way, consistent time stamping over all field communication hubs may be achieved.

Upon operation of the system 10 in FIG. 1, a tank filling level value is determined by the first field device 12a, and a tank temperature or pressure value is determined by the second field device 12b. A first time stamp based on the external time signal is applied by the time stamping unit 24 to the tank filling level value from the first field device 12a when the tank filling level value is received by the field communication hub 18, and a second time stamp based on the external time signal is applied by the time stamping unit 24 to the tank temperature or pressure value from the second field device 12b when the tank temperature or pressure value is received by the field communication hub 18. The tank filling level value is stored in the data storage 20 of the field communication hub 18 along with the first time stamp and the field device ID of the first field device 12a, and the tank temperature or pressure value is stored in the data storage 20 of the field communication hub 18 along with the second time stamp and the field device ID of the second field device 12b.

The time stamped process variable values may for exampled be used to maintain traceability of e.g. tank levels over time and/or to control the freshness of the process variable values.

Conveniently, the single time stamping unit 24 of the system 10 in FIG. 1 may “handle” a plurality of field devices, and existing field devices do not have to be upgraded to provide the time stamps.

FIG. 2 illustrates a tank gauging system 10 according to another embodiment of the present invention, wherein each field device has its own time stamping unit instead of a common time stamping unit in the field communication hub.

The system 10 of FIG. 2 comprises two field devices 12a, 12b. Each field device 12a, 12b is adapted to determine a process variable of a tank 14, and to provide a process variable value corresponding to the determined process variable. The first field device 12a may for example be adapted to detect a filling level of a product 16 contained in the tank 14. The first field device 12a may for example be a non-contact radar level gauge or a guided wave radar level transmitter. The second field 12b may for example detect tank temperature, pressure, or the like.

Each field device 12a, 12b also has a unique field device identification (ID). The field device identification may for example be a unique number, name or other digital and/or electronic designation associated with the field device in question.

The system 10 of FIG. 2 further comprises a field communication hub 18. The field communication hub comprises an electronic data storage (memory) 20. The field communication hub 18 is generally adapted to receive process variable values from the field devices 12a, 12b, and to store each received process variable value in the data storage 20 along with the field device identification associated with the field device that the particular process variable value was received from. The field communication hub 18 may for example poll the field devices 12a, 12b in order to receive the process variable values. Communications between the field devices 12a, 12b and the field communication hub 18 may be wired or wireless. A tank hub 22 may optionally be arranged between the field devices 12a, 12b and the field communication hub 18, as shown in FIG. 2.

The system 10 shown in FIG. 2 further comprises a first time stamping unit 24a and a second time stamping unit 24b. The first time stamping unit 24a is associated with, and preferably integrated in, the first field device 12a. Likewise, the second time stamping unit 24b is associated with, and preferably integrated in, the second field device 12b. The time stamping units 24a, 24b may be realized with suitable software and/or hardware. Each time stamping unit 24a, 24b is adapted to apply an electronic time stamp to a process variable value provided by its field device. The time stamp may for example be applied when the process variable value is sampled by the field device. In this way, the time stamp is more accurate to the time for the actual sampling of the process variable value. The applied time stamps are based on an external time signal (indicated by dotted arrow in FIG. 2) received from outside of the system 10. The external time signal is typically electronic. Both time stamping units 24a, 24b may receive the same external time signal, so that they are synchronized. Each time stamp is typically digital and/or electronic, and it may comprise time and date. It may also comprise UTC (Coordinated Universal Time), time zone data, daylight saving data, etc. Each process variable value and time stamp combination may be sent to the field communication hub 18, where it is stored in the data storage 20 along with the associated field device identification, as exemplified in FIG. 2.

The external time signal may for example come from an external time standard 28, such as an atomic clock. The external time signal may generally be received by at least one input of the system 10, for example via radio. In particular, the time stamping units 24a, 24b may be configured to receive the external time signal directly from the external time standard 28, as shown in FIG. 2. Alternatively, the external time signal may be distributed to the time stamping units 24a, 24b via a bus 34 of the system 10.

The system 10 of FIG. 2 may further comprise a control room 32 connected to field communication hub 18, whereby data stored in the field communication hub 18 promptly can be sent to the control room 32. The control room 32 may calculate a volume of the product 16 based on the detected level, which calculated volume may be electronically stored along with the time stamp related to the detected level.

Upon operation of the system 10 in FIG. 2, a first time stamp based on the external time signal is applied by the first time stamping unit 24a to the tank filling level value of the first field device 12a when the tank filling level value is sampled by the first field device 12a, and a second time stamp based on the external time signal is applied by the second time stamping unit 24b to a tank temperature or pressure value of the second field device 12b when the tank temperature or pressure value is sampled by the second field device 12b. The tank filling level value is stored in the data storage 20 of the field communication hub 18 along with the first time stamp and the field device ID of the first field device 12a, and the tank temperature or pressure value is stored in the data storage 20 of the field communication hub 18 along with the second time stamp and the field device ID of the second field device 12b.

The time stamped process variable values may for exampled be used to maintain traceability of e.g. tank levels over time and/or to control the freshness of the process variable values.

The present invention may for example be implemented in the Raptor System provided by Rosemount Tank Gauging. The Raptor System is for example described in the brochure “The all-new Raptor tank gauging system Always ready for your next challenge” from Rosemount Tank Gauging, the content of which herein is incorporated by reference.

The person skilled in the art realizes that the present invention by no means is limited to the preferred embodiments described above. On the contrary, many modifications and variations are possible within the scope of the appended claims. For example, the systems disclosed in FIGS. 1 and 2 could comprise only one or more than two field devices. Furthermore, not only process variable values but also error/warning information from the field devices can be time stamped in accordance with the present invention.

1. A tank gauging system, comprising:
a field device adapted to determine a process variable of a tank and to provide a process variable value corresponding to the determined process variable, wherein the field device has a field device identification;
a time stamping unit adapted to apply an electronic time stamp to said process variable value; and
a field communication hub comprising a data storage, wherein the field communication hub is adapted to receive said process variable value from the field device and to store the received process variable value along with the field device identification and the electronic time stamp in said data storage,
wherein the system is configured to receive an external time signal, and wherein the applied electronic time stamp is based on the received external time signal.

2. A tank gauging system according to claim 1, wherein the time stamping unit is included in the field communication hub.

3. A tank gauging system according to claim 2, wherein the applied electronic time stamp is the current time and date as indicated by the external time signal when the process variable value is received by the field communication hub.

4. A tank gauging system according to claim 2, wherein the field communication hub comprises an internal clock which is synchronized by the external time signal, and wherein the applied electronic time stamp is the current time and date of the internal clock when the process variable value is received by the field communication hub.

5. A tank gauging system according to claim 1, wherein the time stamping unit is included in the field device.

6. A tank gauging system according to claim 5, wherein the applied electronic time stamp is the current time and date as indicated by the external time signal when the process variable value is sampled by the field device.

7. A tank gauging system according to claim 1, wherein the external time signal is provided from an external time standard outside of the tank gauging system.

8. A tank gauging system according to claim 1, further comprising an internal computer adapted to receive the external time signal from outside of the system.

9. A tank gauging system according to claim 1, wherein the process variable is a filling level of a product contained in the tank.

10. A tank gauging system according to claim 1, wherein the field device is a radar level gauge.

11. A tank gauging system according to claim 1, further comprising a second field device adapted to determine a second process variable of said tank or another tank and to provide a second process variable value corresponding to the second determined process variable, the second field device having a second field device identification,
wherein the field communication hub is adapted to receive the second process variable value from the second field device and to store the received second process variable value along with the second field device identification and a second electronic time stamp applied by the time stamping unit to the second process variable value based on the external time signal.

12. A tank gauging method, comprising:
in a time stamping unit of a tank gauging system, applying an electronic time stamp to a process variable value, the process variable value corresponding to a process variable of a tank, which process variable is determined by a field device of the tank gauging system, wherein the applied electronic time stamp is based on an external time signal; and
in a field communication hub of the tank gauging system, storing the process variable value along with the electronic time stamp and a field device identification of said field device.

13. A tank gauging method according to claim 12, wherein the electronic time stamp is applied when the process variable value is received by the field communication hub.

14. A tank gauging method according to claim 12, wherein the electronic time stamp is applied when the process variable value is sampled by the field device.

15. A tank gauging method according to claim 12, further comprising: receiving the external time signal from a time standard outside of the tank gauging system.

101-115. (canceled)
